(19) United States
(12) Patent Application Publication
(10) Pub. No.: US 2012/0166048 A1
(43) Pub. Date: Jun. 28, 2012

(54) INVERTED PENDULUM TYPE MOVING BODY

(75) Inventors: Hidefumi Inoue, Saitama (JP); Tomohiro Kawamoto, Saitama (JP)

(73) Assignee: BOSCH CORPORATION, Tokyo (JP)

(21) Appl. No.: 13/313,117

(22) Filed: Dec. 7, 2011

(30) Foreign Application Priority Data
Dec. 15, 2010 (JP) 2010-278700

(51) Int. Cl. G05D 1/08

(52) U.S. Cl. 701/49

(57) ABSTRACT

An inverted pendulum type moving body subject to a traveling control in response to a traveling instruction based on an intention of a rider while keeping a balance, a manipulation mode is performed based on the intention of the rider and an automatic operation mode is performed without being based on the intention of the rider.

The inverted pendulum type moving body includes a center-of-gravity position adjusting unit for adjusting a center-of-gravity position of the rider in accordance with a manipulation signal outputted from a control device. When an instruction for switching a control mode to an automatic operation mode, where a predetermined traveling control is performed without being based on intention of the rider, is generated, and controls a wheel drive unit in accordance with a traveling instruction based on the center-of-gravity position.

### BACKGROUND OF INVENTION

The present invention relates to an inverted pendulum type moving body which is subject to a traveling control while keeping a balance in accordance with a traveling instruction based on intention of a rider.

Conventionally, there has been known an inverted pendulum type moving body where an unstable vehicle which is liable to overturn is configured to travel in a stable manner while keeping a balance. As one mode of this inverted pendulum type moving body, there has been known a coaxial two-wheeled vehicle which includes a pair of wheels arranged on the same axis, and travels while keeping a balance of a vehicle body by controlling outputs of electrically-operated motors which rotatably drive the pair of wheels based on the shift of the center of gravity by the rider.

In such a coaxial two-wheeled vehicle, a travelling control is performed by superposing a translation motion control which follows a traveling target value for a forward motion or a backward motion generated based on the shift of center of gravity of a rider and an inversion control where a feedback control or a robust control is performed so as to prevent the overturn of an unstable vehicle (for example, see JP-A-63-305082 and JP-A-2004-295430).

### SUMMARY OF THE INVENTION

In inverted pendulum type moving bodies which have been developed so far including the above-mentioned coaxial two-wheeled vehicle, the control of the inverted pendulum type moving body is performed in a manipulation mode where a traveling control is performed based on the shift of a weight of the rider. On the other hand, if the rider could use the inverted pendulum type moving body by switching a control mode to an automatic operation mode where a traveling control is performed without being based on intention of the rider, that is, by using a traveling target value generated by a certain algorithm based on the communication with another moving body, the inputting of traveling information or the recognition of an environment using sensors or the like, places or cases where the inverted pendulum type moving body can be used are remarkably increased in number and hence, the inverted pendulum type moving body becomes more useful.

However, as described previously, the traveling control of the inverted pendulum type moving body is performed by superposing the translation motion control and the inversion control and hence, when a rider shifts his weight during the traveling control in the automatic operation mode, an inversion control is performed to prevent the overturn of a vehicle body in response to the weight shift thus influencing the translation motion control. For example, in the case where a traveling target value generated in the automatic operation mode is a target value instructing the deceleration or the stop, when the rider inclines frontward so that his center of gravity is inclined frontward, a frontward motion instruction is outputted so as to prevent the overturn of the vehicle body in the inversion control.

In this manner, in a state where there is a possibility that the translation motion control and the inversion control output the instructions which are contradictory to each other in an automatic operation mode, it is difficult to realize the inverted pendulum type moving body where a control mode can be switched between the manipulation mode and the automatic operation mode.

In view of these drawbacks, inventors of the present invention have found that during a period where the traveling control is performed in an automatic operation mode, the above-mentioned drawback can be overcome by setting the position of the center of gravity adjustable such that the position of the center of gravity of a rider becomes the position of the center of gravity for realizing a target traveling state. The inventors of the present invention have achieved the present invention based on such finding.

Accordingly, it is an object of the present invention to provide an inverted pendulum type moving body which is subject to a traveling control in response to a traveling instruction based on intention of the rider while keeping a balance, wherein the inverted pendulum type moving body can realize a manipulation mode which is performed based on intention of a rider and an automatic operation mode which is performed without being based on intention of the rider.

According to one aspect of the present invention, there is provided an inverted pendulum type moving body which includes: a vehicle body having a riding part on which a rider rides; a pair of wheels which is arranged on the same axis and is rotatably supported on the vehicle body; a wheel drive unit which rotatably drives the wheels; a center-of-gravity position detecting unit for detecting a center-of-gravity position of the rider; and a control device which controls the wheel drive unit for making the vehicle body travel while keeping a balance in accordance with a traveling instruction based on intention of the rider, wherein the inverted pendulum type moving body further includes a center-of-gravity position adjusting unit for adjusting the center-of-gravity position of the rider in accordance with a manipulation signal outputted from the control device, and the control device controls, when an instruction for switching a control mode to an automatic operation mode where a predetermined traveling control is performed without being based on intention of the rider is generated, the center-of-gravity position adjusting unit such that the center-of-gravity position where a target traveling state is realized is obtained, and controls the wheel drive unit in accordance with a traveling instruction based on the center-of-gravity position. Due to the provision of such an inverted pendulum type moving body, the above-mentioned drawbacks can be overcome.

That is, the inverted pendulum type moving body of the present invention includes the center-of-gravity position adjusting unit for adjusting the center-of-gravity position and, during the automatic operation mode, the control device controls the center-of-gravity position adjusting unit such that a control signal for the wheel drive unit outputted in accordance with the center-of-gravity position takes a value corresponding to a target traveling state. Accordingly, it is possible to perform a traveling control of the inverted pendulum type moving body in an automatic operation mode without generating a conflict between an output of an inversion control for preventing overturn of the moving body and an output of a translation motion control for obtaining a predetermined traveling state. Accordingly, it is possible to realize an inverted pendulum type moving body which can switch a control mode between a manipulation mode and an automatic operation mode.

Further, in constituting the inverted pendulum type moving body of the present invention, it is preferable that the control device may preferably decide a manipulated variable of the center-of-gravity position adjusting unit based on a target center-of-gravity position for realizing a target traveling state and a center-of-gravity position detected using the center-of-gravity position detecting unit.

According to the present invention, by constituting the control device such that the manipulated variable of the center-of-gravity position adjusting unit is decided based on the target center-of-gravity position and the current center-of-gravity position, the center-of-gravity position is adjusted corresponding to the displacement between the target center-of-gravity position and the current center-of-gravity position and hence, the center-of-gravity position can be rapidly shifted to the target center-of-gravity position.

Further, in constituting the inverted pendulum type moving body of the present invention, it is preferable that the automatic operation mode includes an automatic obstacle avoiding operation mode where an obstacle avoiding operation is automatically performed, the inverted pendulum type moving body includes an obstacle detecting unit which detects information on an obstacle present in the periphery of the inverted pendulum type moving body, and the control device switches a control mode to the automatic obstacle avoiding operation mode based on the traveling information on the inverted pendulum type moving body and the information on the obstacle and outputs a manipulation signal for avoiding the obstacle.

According to the present invention, by constituting the inverted pendulum type moving body such that the traveling control can be performed in the automatic obstacle avoiding operation mode as the automatic operation mode, when a person, an obstacle, a step or the like approaches the inverted pendulum type moving body during traveling, an operation to avoid such an obstacle is performed so that the collision or overturn of the inverted pendulum type moving body can be prevented.

Further, in constituting the inverted pendulum type moving body of the present invention, it is preferable that the automatic operation mode includes an automatic cooperation operation mode where a cooperation operation with another moving body is automatically performed, the control device switches a control mode to the automatic cooperation operation mode upon receiving an instruction for starting the cooperation operation, and outputs the manipulation signal in response to traveling information on another moving body.

According to the present invention, by constituting the inverted pendulum type moving body such that the traveling control can be performed in the automatic cooperation operation mode as the automatic operation mode, the inverted pendulum type moving body can travel following another moving body even when the rider does not shift the center of gravity himself.

Further, in constituting the inverted pendulum type moving body of the present invention, it is preferable that the automatic operation mode includes an automatic guide operation mode where an automatic guide operation is performed until the moving body reaches a destination, the control device switches a control mode to the automatic guide operation mode upon receiving an instruction for starting the automatic guide operation, and outputs the manipulation signal in response to the set target traveling information.

According to the present invention, by constituting the inverted pendulum type moving body such that the traveling control can be performed in the automatic guide operation as the automatic operation mode, the inverted pendulum type moving body can travel to the predetermined destination even when the rider does not shift the center of gravity himself.

Further, in constituting the inverted pendulum type moving body of the present invention, it is preferable that the center-of-gravity position adjusting unit is constituted of a riding part inclination angle varying mechanism having a unit which adjusts an inclination angle of the riding part with respect to the horizontal direction in response to the manipulation signal.

According to the present invention, by constituting the center-of-gravity position adjusting unit using the mechanism which can change the inclination angle of the riding part with respect to the horizontal direction, there is no possibility that the riding part is shifted in the planar direction and hence, it is possible to prevent the increase of a size of the moving body in the planar direction and, at the same time, the center-of-gravity position can be shifted in various directions.

Further, in constituting the inverted pendulum type moving body of the present invention, it is preferable that the center-of-gravity position adjusting unit is constituted of a riding part position varying mechanism having a unit which adjusts a position of the riding part with respect to the vehicle body in response to a manipulation signal.

According to the present invention, by constituting the center-of-gravity position adjusting unit using the mechanism which can change the position of the riding part with respect to the vehicle body, the center-of-gravity position can be directly shifted by sliding the riding part in plane and hence, the adjustment of the center-of-gravity position can be easily performed.

Further, in constituting the inverted pendulum type moving body of the present invention, it is preferable that the center-of-gravity position adjusting unit is constituted of an inertial body whose position is changeable with respect to the vehicle body, and a unit which adjusts the position of the inertial body in response to a manipulation signal.

According to the present invention, by constituting the center-of-gravity position adjusting unit using the inertial body whose position can be shifted relative to the vehicle body, the center-of-gravity position can be shifted without moving the riding part and hence, a discomfort which a rider feels can be reduced.

### BRIEF DESCRIPTION OF THE DRAWINGS

FIG. 1A and FIG. 1B are a front view and a side view of an inverted pendulum type moving body according to a first embodiment of the present invention;

FIG. 2 is a block diagram showing a control circuit of the inverted pendulum type moving body according to the first embodiment;

FIG. 3 is a flowchart for explaining one example of a method of controlling the inverted pendulum type moving body of the present invention;

FIG. 4 is a flowchart for explaining one example of an automatic operation switching determination in the method of controlling the inverted pendulum type moving body according to the first embodiment;

FIG. 5 is a flowchart for explaining one example of a method of deciding a target traveling state in the method of controlling the inverted pendulum type moving body according to the first embodiment;

FIG. 6A and FIG. 6B are a front view and a side view of an inverted pendulum type moving body according to a second embodiment of the present invention;

FIG. 7 is a block diagram showing a control circuit of the inverted pendulum type moving body according to the second embodiment;

FIG. 8 is a flowchart for explaining one example of an automatic operation switching determination in the method of controlling the inverted pendulum type moving body according to the second embodiment and a third embodiment;

FIG. 9A and FIG. 9B are a front view and a side view of an inverted pendulum type moving body according to the third embodiment of the present invention;

FIG. 10 is a block diagram showing a control circuit of the inverted pendulum type moving body according to the third embodiment;

FIG. 11A and FIG. 11B are a front view and a side view of another inverted pendulum type moving body having a center-of-gravity position detecting unit having the different constitution; and

FIG. 12A and FIG. 12B are a front view and a side view of still another inverted pendulum type moving body having a center-of-gravity position detecting unit having the different constitution.

### DETAILED DESCRIPTION

Hereinafter, embodiments of an inverted pendulum type moving body according to the present invention are explained specifically in conjunction with drawings suitably. Here, the embodiments explained hereinafter merely describe one mode of the present invention, and the present invention is not limited to the embodiments and may be arbitrarily changed within the scope of the present invention.

In the respective drawings, parts to which the same symbols are given are indicated as identical parts, and the repeated explanation of these parts is omitted when appropriate.

Firstly, as an inverted pendulum type moving body (hereinafter simply referred to as “moving body”) according to the first embodiment of the present invention, the explanation is made with respect to an inverted pendulum type moving body which is constituted such that a traveling control can be performed in an automatic obstacle avoiding operation mode as an automatic operation mode.

1. Constitution of Inverted Pendulum Type Moving Body

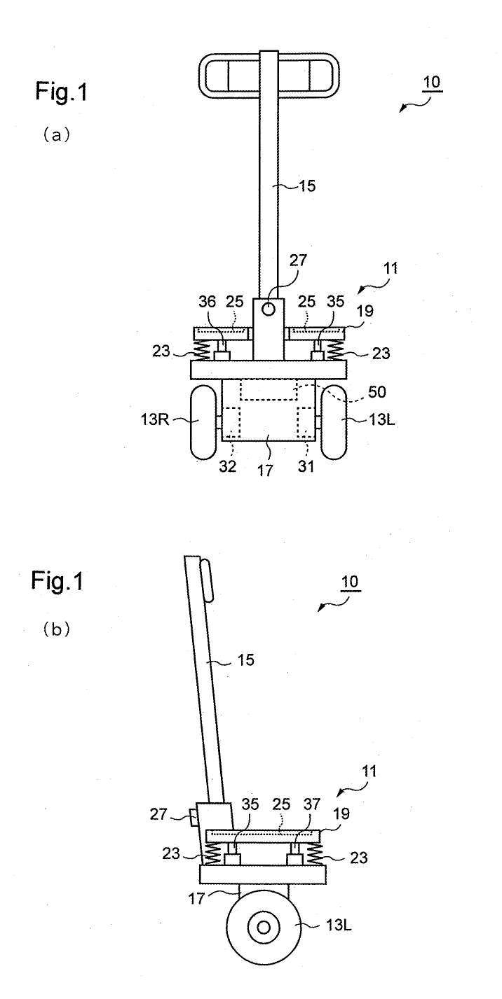

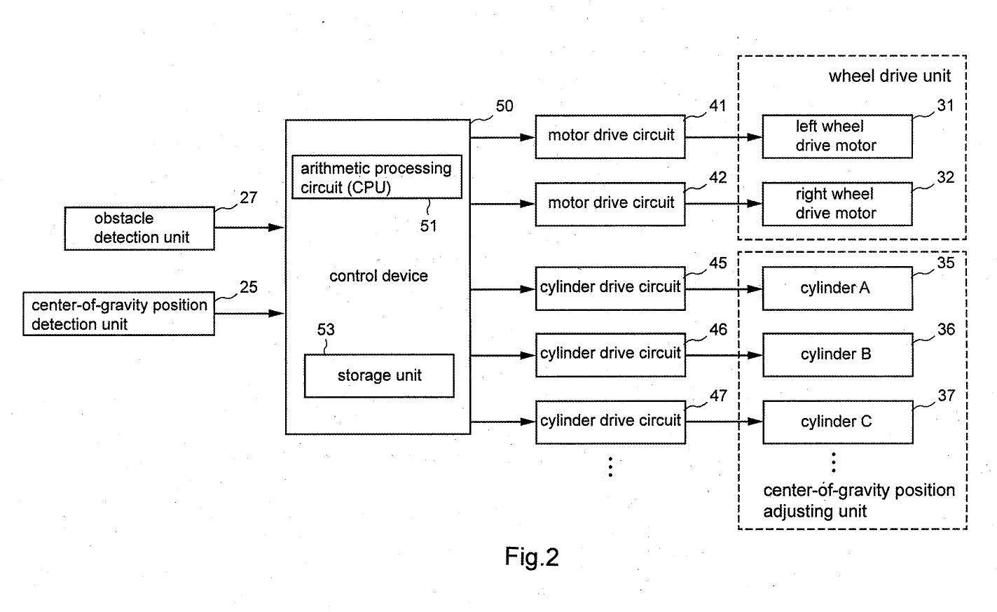

FIG. 1A is a front view showing a moving body 10 of this embodiment, and FIG. 1B is a side view showing the moving body 10. FIG. 2 is a block diagram showing a control circuit of the moving body 10 of this embodiment.

The moving body 10 is constituted as a coaxial two-wheeled vehicle which includes a vehicle body 11, a pair of right and left wheels 13R, 13L and a handle 15. The pair of right and left wheels 13R, 13L is arranged on the same axis on both sides of the moving body 10 in the lateral direction orthogonal to the longitudinal direction of the moving body 10 and, at the same time, is supported on the vehicle body 11 in a rotatable manner relative to the vehicle body 11. The pair of right and left wheels 13R, 13L is connected to a right wheel drive motor 32 and a left wheel drive motor 31 which constitute wheel drive units housed in a motor box 17.

A riding part 19 on which a rider places his both feet during riding is formed on an upper surface of the vehicle body 11. A center-of-gravity position adjusting unit is mounted on the riding part 19. In the moving body 10 of this embodiment, the center-of-gravity position can be adjusted by adjusting an inclination angle of the riding part 19 with respect to the horizontal direction.

The example of the moving body 10 shown in FIG. 1A and FIG. 1B adopts the mechanism where the riding part 19 is supported by a plurality of coil springs 23 which elastically support the riding part 19 and a plurality of cylinders consisting of a cylinder A35, a cylinder B36, a cylinder C37 . . . which are extensible and retractable in the vertical direction, and the inclination angle of the riding part 19 can be changed by adjusting extension/retraction amounts of the respective cylinders consisting of the cylinder A35, the cylinder B36, the cylinder C37 . . . . By forming the center-of-gravity position adjusting unit into such a mechanism, the moving body 10 is configured such that the riding part 19 does not shift in the planar direction thus preventing the increase of a size of the moving body 10 in the planar direction.

As the plurality of cylinders consisting of the cylinder A35, the cylinder B36, the cylinder C37 . . . which form the center-of-gravity position adjusting unit, known cylinders such as electrically-operated cylinders, hydraulic cylinders or pneumatic cylinders can be used. Further, the constitution of the mechanism for changing an inclination angle is not limited to the above-mentioned example.

Further, a center-of-gravity position detecting unit 25 for detecting the center-of-gravity position of a rider is provided to the vehicle body 11. As the center-of-gravity position detecting unit 25, for example, pressure sensitive sensors which are mounted on an upper surface or the inside of the riding part 19 are used. When the pressure sensitive sensors are used, the center-of-gravity position of a rider can be detected based on the distribution of the detected pressures. As the center-of-gravity position detecting unit 25, besides the pressure sensitive sensor, it is also possible to use a strain gauge which is configured to detect the center-of-gravity position of the rider by detecting electrostatic capacity corresponding to the center-of-gravity position, or an inclination angle sensor or a gyro sensor which is formed using an angular velocity sensor and is configured to detect the center-of-gravity position of the rider by detecting an inclination angle with respect to the horizontal direction.

Further, the moving body 10 of this embodiment includes an obstacle detection unit 27 for detecting information on an obstacle present around the moving body 10. This obstacle detection unit 27 is used for detecting information on an object which becomes an obstacle in traveling of the moving body 10 such as a person, an obstacle or a step present in the traveling direction of the moving body 10. As typical examples of the obstacle detection unit 27, a sensor which detects an obstacle by transmitting or receiving ultrasonic waves, infrared rays, electromagnetic waves such as laser beams, radar beams or millimeter waves or optical waves and the like can be named. However, the obstacle detection unit 27 is not limited to these sensors.

Further, the inverted pendulum type moving body 10 includes a control device 50 which performs a drive control of the left wheel drive motor 31 and the right wheel drive motor 32 which drive the pair of wheels 13L, 13R, and the cylinder A35, the cylinder B36, the cylinder C37 . . . which adjust an inclination angle of the riding part 19. The control device 50 is basically configured to control outputs of the left wheel drive motor 31 and the right wheel drive motor 32 such that the moving body 10 advances or retracts while keeping a balance in accordance with a center-of-gravity position of a rider detected using the center-of-gravity position detection unit 25. The center-of-gravity position of the rider which becomes a basis for deciding outputs of the left wheel drive motor 31 and the right wheel drive motor 32 is placed at a desired position based on the intention of the rider in the manipulation mode, while the center-of-gravity position of the rider is shifted due to the adjustment of extension/retraction amounts of the cylinder A35, the cylinder B36, the cylinder C37 . . . by the control device 50 in the automatic operation mode.

The control device 50 is constituted of, for example, an arithmetic processing circuit 51 which has a microcomputer (CPU), a storage unit 53 which has a program memory, a data memory and other RAMs and ROMs and the like. The control device 50 can receive a detection signal from the obstacle detection unit 27 which detects obstacle information and a detection signal from the center-of-gravity position detection unit 25.

Further, to the control device 50, motor drive circuits 41, 42 which drive the left wheel drive motor 31 and the right wheel drive motor 32 respectively, and cylinder drive circuits 45, 46, 47, . . . which drive the cylinder A35, the cylinder B36, the cylinder C37 . . . for adjusting an inclination angle of the riding part 19 respectively are connected.

The motor drive circuits 41, 42 individually control rotation speeds, rotational directions and the like of the pair of wheels 13L, 13R, and the left wheel drive motor 31 and the right wheel drive motor 32 are individually connected to the motor drive circuits 41, 42. The cylinder drive circuits 45, 46, 47, . . . individually control the extension/retraction of the cylinder A35, the cylinder B36, the cylinder C37 . . . , and the cylinder A35, the cylinder B36, the cylinder C37 . . . are individually connected to the cylinder drive circuit 45, 46, 47, . . . .

2. Method of Controlling Inverted Pendulum Type Moving Body

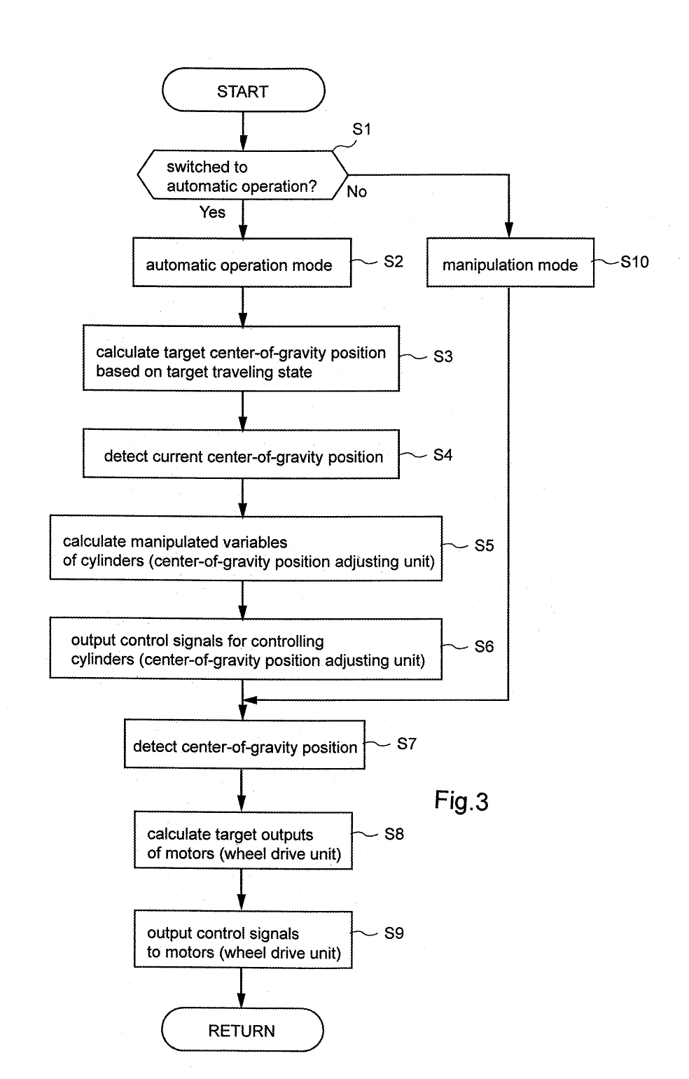

Next, the method of controlling the inverted pendulum type moving body 10 according to this embodiment is explained in conjunction with flowcharts shown in FIG. 3 to FIG. 5.

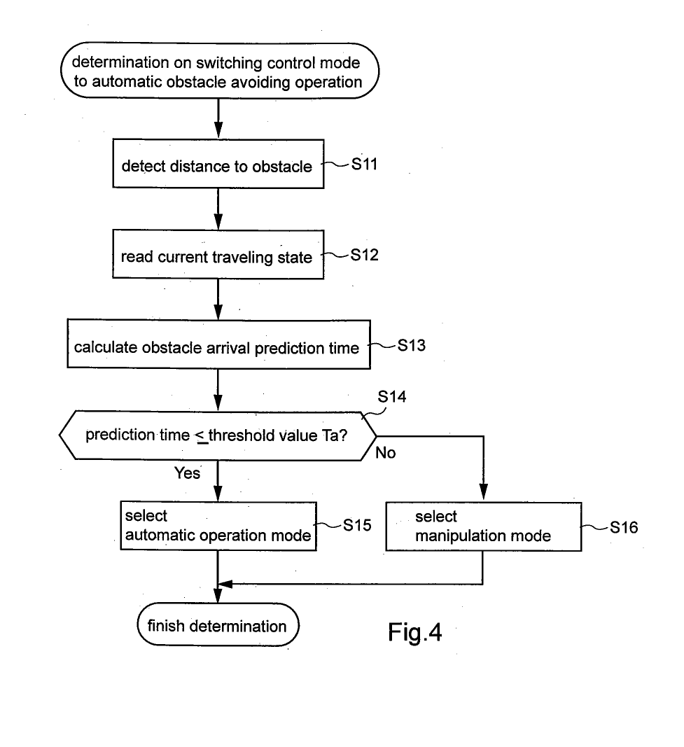

Firstly, in step S1 shown in FIG. 3, the control device 50 determines whether or not a control mode of the moving body 10 is switched to the automatic operation mode. FIG. 4 shows one example of a specific flow of the determination on switching the control mode to the automatic obstacle avoiding operation mode in the moving body 10 of this embodiment which can execute a traveling control in the automatic obstacle avoiding operation mode.

In FIG. 4, firstly, in step S11, the control device 50 calculates a distance from the moving body 10 to an obstacle based on a detection signal of the obstacle detection unit. Next, in step S12, the control device 50 reads a current traveling state of the moving body 10 such as rotational speeds and rotational directions of the respective wheels and the like. Thereafter, in step S13, the control device 50 predicts an arrival time to the obstacle by executing calculation based on the distance detected in step S11 and the traveling state read in step S12.

When an arrival prediction time is acquired, in step S14, the control device 50 determines whether or not the arrival prediction time is a threshold value Ta or less. The threshold value Ta at this point of time is a value which defines timing at which the control mode is switched to the automatic obstacle avoiding operation mode, and the threshold value Ta can be suitably set by taking into account safety and the like in advance.

When the determination in step S14 is affirmative, that is, when the obstacle arrival prediction time is the threshold value Ta or less, the processing advances to step S15 where the control device 50 selects the automatic operation mode and finishes the automatic operation switching determination. On the other hand, when the determination in step S14 is negative, that is, when the obstacle arrival prediction time exceeds the threshold value Ta, the processing advances to step S16 where the control device 50 selects the manipulation mode and finishes the automatic operation switching determination. In accordance with such an example, the determination in step S1 shown in FIG. 3 is performed.

Returning to FIG. 3, when the result of the determination in step S1 is negative, the processing advances to step S10 where the control device 50 switches a control mode to the manipulation mode or maintains the manipulation mode. In this case, the control device 50 advances to step S7 where a current center-of-gravity position of a rider is detected based on a detection signal from the center-of-gravity position detection unit 25. The center-of-gravity position at this point of time is adjusted to a desired position based on the intention of the rider.

After the center-of-gravity position is detected, in step S8, the control device 50 obtains target outputs of the left wheel drive motor 31 and the right wheel drive motor 32 which drive the pair of wheels 13L, 13R by calculation. For example, the target outputs are calculated based on output map information stored in the storage unit 53 of the control device 50 in advance. Here, the target outputs may be calculated by taking into account not only the center-of-gravity position but also a shift amount of the center of gravity per unit time (center-of-gravity shift speed).

Next, in step S9, the target outputs of the left wheel drive motor 31 and the right wheel drive motor 32 obtained in step S8 are converted into control signals indicative of current values, and the control signals are outputted to the motor drive circuits 41, 42. As the result, the pair of wheels 13L, 13R is respectively rotatably driven by the left wheel drive motor 31 and the right wheel drive motor 32, and a traveling state which follows the intention of a rider can be realized.

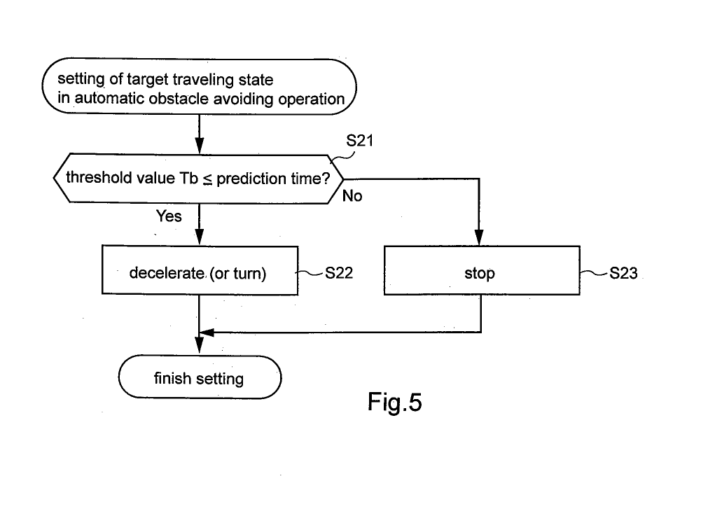

On the other hand, when the result of the determination in step S1 is affirmative, the processing advances to step S2 where the control device 50 switches the control mode to the automatic operation mode or maintains the automatic operation mode. In this case, the control device 50 advances to step S3 where the control device 50 obtains a target center-of-gravity position based on a target traveling state by calculation. FIG. 5 shows one example of a specific flow of a method of deciding a target traveling state in the moving body 10 of this embodiment which can execute a traveling control in the automatic obstacle avoiding operation mode.

In FIG. 5, firstly, in step S21, the control device 50 determines whether or not the arrival prediction time calculated in step S13 in FIG. 4 is a threshold value Tb or more. The threshold value Tb at this point of time is a value set for determining how close the moving body 10 approaches an obstacle, and is used as the reference for selecting either the temporary deceleration of the moving body 10 or rapid stopping of the moving body 10 in the automatic obstacle avoiding operation. This threshold value Tb is also suitably set by taking into account safety and the like in advance.

When the determination in step S21 is affirmative, the processing advances to step S22 where the control device 50 sets a target traveling state by selecting the execution of a control for decelerating the moving body 10. The manner of deceleration is not particularly limited, and various modes can be considered. For example, in the deceleration of the moving body 10, a speed of the moving body 10 is controlled to a preset speed or the speed of the moving body 10 may be decelerated to a predetermined rate or a predetermined amount using a current speed of the moving body 10 as the reference. Further, the moving body 10 may be turned by controlling the pair of wheels 13L, 13R with different outputs respectively.

On the other hand, when the determination in step S21 is negative, the processing advances to step S23 where the control device 50 sets a target traveling state by selecting the execution of the control for rapidly stopping the moving body 10. The manner of stopping the moving body 10 is not particularly limited, and various modes can be considered.

Returning to FIG. 3, in step S3, a target center-of-gravity position for realizing a target traveling state set as in the case of the example shown in FIG. 5 is obtained. For example, the target center-of-gravity position is calculated based on center-of-gravity position map information stored in the storage unit 53 of the control device 50 in advance. In the center-of-gravity position map information, the target center-of-gravity position is decided in accordance with target outputs of the left wheel drive motor 31 and the right wheel drive motor 32 which drive the pair of wheels 13L, 13R and a balance of the moving body 10. Alternatively, the target center-of-gravity position may be calculated using a predetermined calculation formula.

Next, in step S4, the control device 50 detects a current center-of-gravity position based on a detection signal from the center-of-gravity position detection unit 25 and, thereafter, in step S5, the control device 50 obtains control variables of the respective cylinders 35, 36, 37, . . . by calculation such that the current center-of-gravity position is shifted to a target center-of-gravity position. Although a calculation method at this point of time is not particularly limited, for example, a moving amount in the X axis direction and a moving amount in the Y axis direction on an X-Y plane which extends in the horizontal direction are obtained, and manipulated variables of the respective cylinders 35, 36, 37, . . . can be decided based on these information.

Next, in step S6, the control device 50 converts the manipulated variables of the respective cylinders 35, 36, 37, . . . into control signals for drive parts of the respective cylinders 35, 36, 37, . . . and outputs the control signals to the cylinder drive circuits 45, 46, 47, . . . . As the result, the shift of the center-of-gravity position is started.

Thereafter, the control device 50, in accordance with the above-mentioned procedures in step S7 to step S9, obtains outputs of the left wheel drive motor 31 and the right wheel drive motor 32 which drive the pair of wheels 13L, 13R corresponding to the center-of-gravity position, converts the outputs into control signals indicative of current values, and outputs the control signals to the motor drive circuits 41, 42. The center-of-gravity position at this point of time is not based on the intention of a rider and is adjusted by the control device 50.

After the control signals are outputted to the motor drive circuit 41, 42 in step S9, the processing returns to step S1 again, and arithmetic processing is repeated in accordance with procedures explained heretofore.

In switching the control mode of the moving body 10 to the automatic operation mode in step S2, to inform a rider of a fact that the moving body 10 approaches an obstacle simultaneously with such switching, a display may be made on an operation panel or the like, an alarm lamp may be turned on or an alarm sound may be generated.

According to the moving body 10 of this embodiment explained heretofore, when it is predicted that a state where the moving body 10 impinges on a person or an obstacle or the moving body 10 runs up onto a step or the like arises during traveling of the moving body 10 based on the intention of a rider, a control mode can be switched to the automatic operation mode. In this automatic operation mode, outputs of the left wheel drive motor 31 and the right wheel drive motor 32 are controlled by shifting a center-of-gravity position based on a target traveling state and hence, there is no possibility that the moving body 10 is brought into a state where a conflict occurs between an output of a translational operation control and an output of an inversion control. Accordingly, it is possible to realize the moving body 10 which can automatically obviate the collision or the like during traveling based on the intention of a rider.

Further, by executing a control for decelerating, turning or stopping the moving body 10, a damage which a rider or the moving body 10 suffers can be reduced not only in the case where the moving body avoids an obstacle but also in case such as a case where the moving body 10 bumps into an obstacle.

Further, the moving body 10 of this embodiment is configured such that, to shift the current center-of-gravity position to the target center-of-gravity position, a manipulated variable of the center-of-gravity position adjusting unit is decided based on a moving amount in the X-axis direction and a moving amount in the Y-axis direction on an X-Y plane which extends in the horizontal direction. Due to such a constitution, the center-of-gravity position can be speedily and accurately shifted to a target center-of-gravity position. Accordingly, it is possible to realize a traveling state for obviating collisions or the like with high accuracy.

Next, as an inverted pendulum type moving body according to a second embodiment of the present invention, the explanation is made with respect to an inverted pendulum type moving body which is constituted such that a traveling control can be performed in an automatic cooperation operation mode as the automatic operation mode.

1. Constitution of Inverted Pendulum Type Moving Body

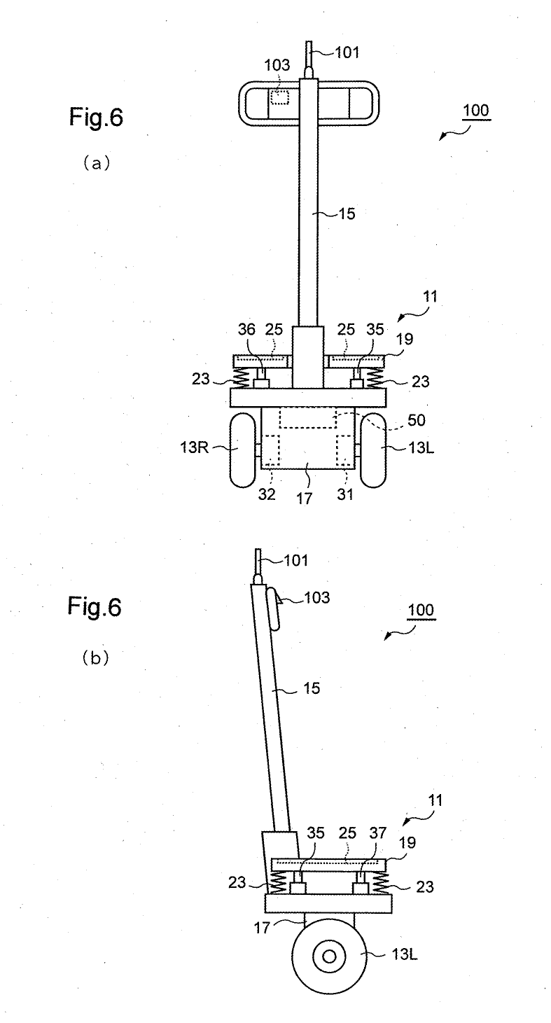

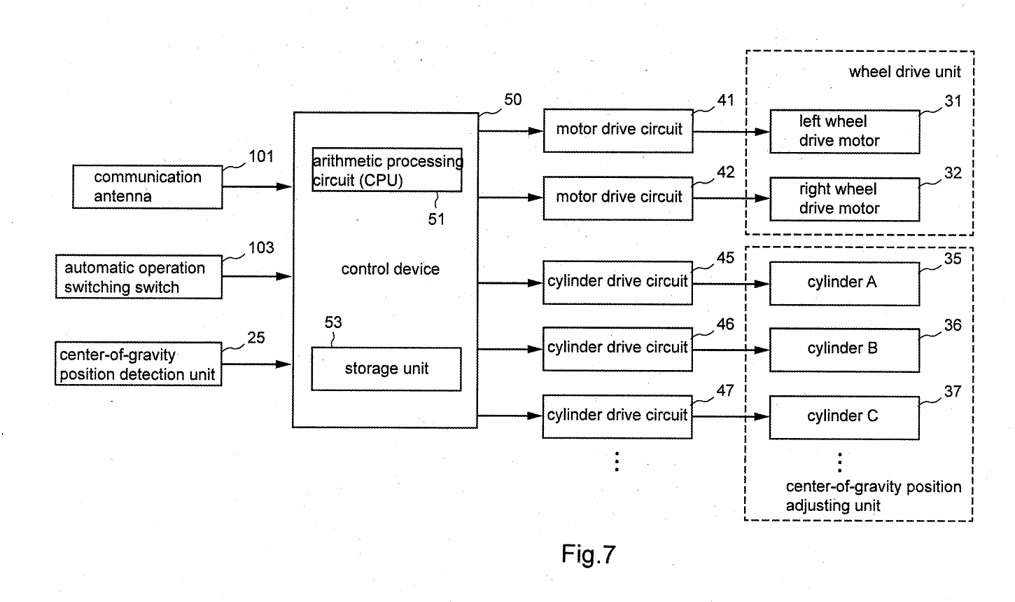

FIG. 6A is a front view showing a moving body 100 of this embodiment, and FIG. 6B is a side view showing the moving body 100. FIG. 7 is a block diagram showing a control circuit of the moving body 100 of this embodiment.

With respect to the external appearance constitution of the moving body 100, although the moving body 100 is not provided with the obstacle detection unit 27 of the moving body 10 of the first embodiment, the moving body 100 is provided with an automatic operation switching switch 103 and a communication antenna 101.

The automatic operation switching switch 103 is a switch for inputting an instruction for executing the automatic cooperation operation, and a switching operation of the automatic operation switching switch 103 is performed by a rider or the like. The automatic operation switching switch 103 may be formed in various modes including a switch button mode, a touch panel mode and the like, and the mode of the automatic operation switching switch 103 is not particularly limited. Further, it may also be possible to generate an instruction for executing the automatic cooperation operation in response to an instruction signal from the outside without using a switching switch. However, in the case of a switching switch which a rider can manipulate, starting and stopping of the automatic cooperation operation can be decided based on the intention of the rider.

In executing the automatic cooperation operation, the communication antenna 101 receives traveling information transmitted from another moving body. As the traveling information, for example, information relating to a drive state of a pair of wheels of another moving body or a control signal or a drive signal for rotatably driving the wheels or the like can be named. Further, when another moving body is also constituted of the moving body 100 of this embodiment, information on target center-of-gravity position can be also used. Further, another moving body is not limited to an inverted pendulum type moving body and hence, other information may be used.

When the moving body 100 becomes a main moving body at the time of executing the automatic cooperation operation, traveling information on own vehicle is transmitted to another moving body via the communication antenna 101.

The automatic operation switching switch 103 and the communication antenna 101 are connected to the control device 50. The control device 50 can receive an instruction signal generated by a switching operation of the automatic operation switching switch 103 as an input, and can detect traveling information on another moving body received by the communication antenna 101.

With respect to constitutional elements relating to the external appearance constitution other than the above-mentioned constitution, these constitutional elements can have the substantially equal constitution as the moving body 10 of the first embodiment and hence, the explanation of these constitutional elements is omitted here.

2. Method of Controlling the Inverted Pendulum Type Moving Body

Next, the method of controlling the inverted pendulum type moving body 100 of this embodiment is explained.

The method of controlling the moving body 100 of this embodiment is basically executed in accordance with steps shown in a flowchart in FIG. 3. However, arithmetic processing performed by the moving body 100 of this embodiment which can execute a traveling control in the automatic cooperation operation mode differs from arithmetic processing performed by the moving body 10 of the first embodiment with respect to step S1 where the determination on switching a control mode to the automatic cooperation operation mode is performed and step S3 where a target center-of-gravity position is calculated based on a target traveling state.

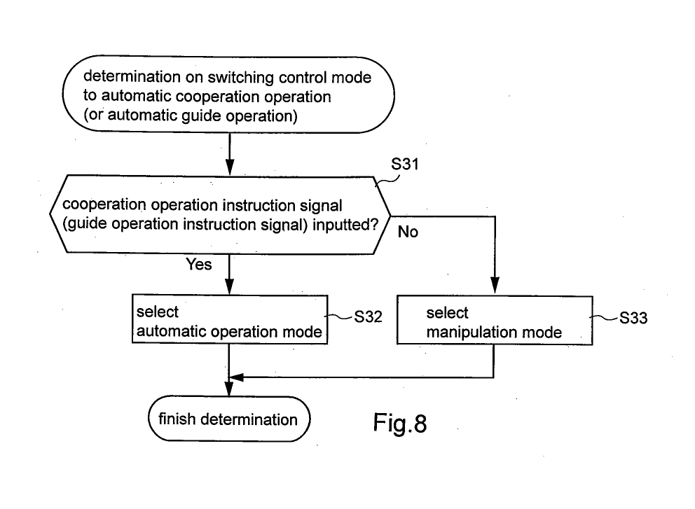

FIG. 8 shows one example of a specific flow of the determination on switching a control mode to the automatic cooperation operation mode in the moving body 100 of this embodiment which can execute a traveling control in the automatic cooperation operation mode. In FIG. 8, firstly, in step S31, the control device 50 determines whether or not a switching instruction signal for switching a control mode to the automatic cooperation operation mode is inputted. When the determination in step S31 is affirmative, the processing advances to step S32, and the control device 50 selects the automatic operation mode and finishes the automatic operation switching determination. On the other hand, when the determination in step S31 is negative, the processing advances to step S33, and the control device 50 selects the manipulation mode and finishes the automatic operation switching determination. In the moving body 100 of this embodiment, the determination in step S1 shown in FIG. 3 is performed in accordance with such an example.

In the moving body 100 of this embodiment, a traveling state of another moving body received via the communication antenna 101 is set as a target traveling state, and a target center-of-gravity position corresponding to the target traveling state is obtained in step S3. Here, in center-of-gravity position map information referenced at the time of obtaining the target center-of-gravity position corresponding to the target traveling state, the center-of-gravity position is positioned on an axis on which the pair of wheels 13L, 13R is arranged in a stationary state (speed of moving body 100=zero), and the center-of-gravity position is decided corresponding to the traveling direction, the turning direction and acceleration. Arithmetic processing in respective steps other than the above-mentioned arithmetic processing is executed substantially in the same manner as the arithmetic processing executed in the first embodiment.

According to the moving body 100 of this embodiment explained heretofore, the manipulation mode where a traveling control of the moving body 100 is executed based on the intention of a rider and the automatic operation mode where a traveling control is executed in corporation with another moving body can be selectively executed. In the automatic operation mode, outputs of the left wheel drive motor 31 and the right wheel drive motor 32 are controlled by shifting the center-of-gravity position based on a target traveling state in accordance with traveling information on another moving body and hence, there is no possibility that a conflict occurs between an output of the translational operation control and an output of the inversion control.

Further, the moving body 100 of this embodiment is also configured such that, to shift the current center-of-gravity position to the target center-of-gravity position, a manipulated variable of the center-of-gravity position adjusting unit is decided based on a moving amount in the X-axis direction and a moving amount in the Y-axis direction on an X-Y plane which extends in the horizontal direction. Due to such a constitution, the center-of-gravity position can be speedily and accurately shifted to a target center-of-gravity position. Accordingly, it is possible to realize a cooperation operation with another moving body with high accuracy.

Next, as an inverted pendulum type moving body according to a third embodiment of the present invention, the explanation is made with respect to an inverted pendulum type moving body which is constituted such that a traveling control can be performed in an automatic guide operation mode as the automatic operation mode.

1. Constitution of Inverted Pendulum Type Moving Body

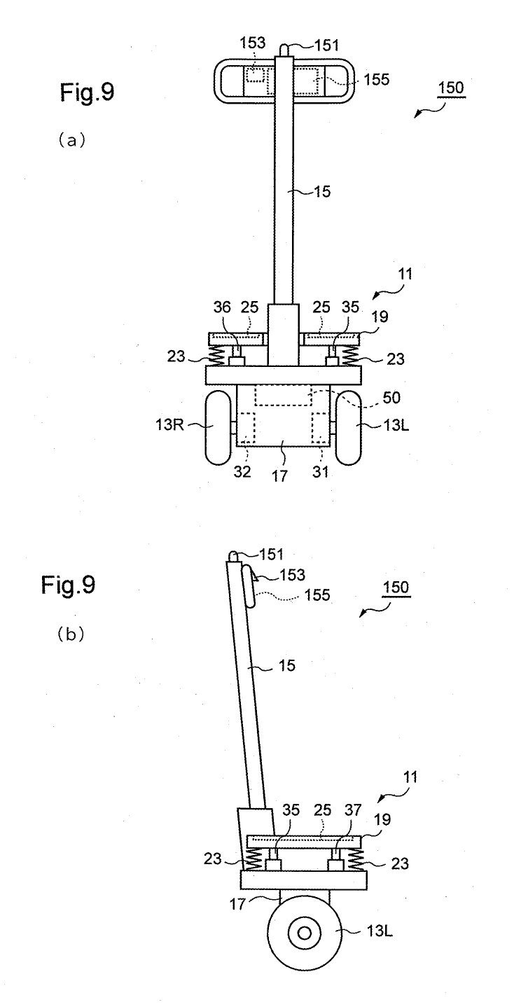

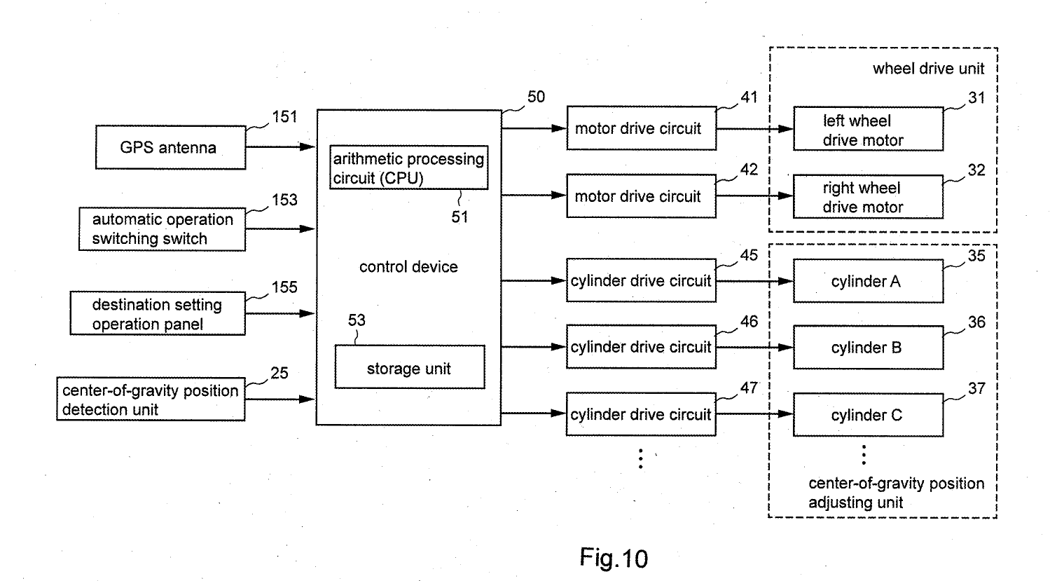

FIG. 9A is a front view showing a moving body 150 of this embodiment, and FIG. 9B is a side view showing the moving body 150. FIG. 10 is a block diagram showing a control circuit of the moving body 150 of this embodiment.

With respect to the external appearance constitution of the moving body 150, although the moving body 150 is not provided with the obstacle detection unit 27 of the moving body 10 of the first embodiment, the moving body 150 is provided with an automatic operation switching switch 153, a GPS antenna 151 and a destination setting operation panel 155.

The automatic operation switching switch 153 is a switch for inputting an instruction for executing the automatic guide operation, and a switching operation of the automatic operation switching switch 153 is performed by a rider or the like. The automatic operation switching switch 153 may be formed, in the same manner as the second embodiment, in various modes including a switch button mode, a touch panel mode and the like, and the mode of the automatic operation switching switch 153 is not particularly limited. Further, it may also be possible to generate an instruction for executing the automatic guide operation in response to an instruction signal from the outside without using a switching switch. However, in the case of a switching switch which a rider can manipulate, start and stop of the automatic guide operation can be decided based on the intention of the rider.

The GPS antenna 151 is provided for detecting a present position of the moving body 150 in executing the automatic guide operation. A known GPS antenna can be used as such a GPS antenna 151.

The destination setting operation panel 155 is constituted of a touch panel, for example. The destination setting operation panel 155 is used for setting the destination, a traveling route and a traveling state such as a speed in advance by a rider or the like. Further, without setting the destination or the like using the destination setting operation panel 155, data information in which a traveling state until the moving body 150 reaches the destination is set may be stored in the control device 50 in advance.

The automatic operation switching switch 153, the GPS antenna 151 and the destination setting operation panel 155 are connected to the control device 50 respectively. The control device 50 can receive an instruction signal generated by a switching operation of the automatic operation switching switch 153 as an input, and can detect position information received by the GPS antenna 151 and traveling information set using the destination setting operation panel 155.

With respect to constitutional elements relating to the external appearance constitution other than the above-mentioned constitution, these constitutional elements can have the substantially equal constitution as the moving body 10 of the first embodiment and hence, the explanation of these constitutional elements is omitted here.

2. Method of Controlling the Inverted Pendulum Type Moving Body

Next, the method of controlling the inverted pendulum type moving body 150 of this embodiment is explained.

The method of controlling the moving body 150 of this embodiment is basically executed in accordance with steps shown in a flowchart shown in FIG. 3. However, arithmetic processing performed by the moving body 150 of this embodiment which can execute a traveling control in the automatic guide operation mode differs from arithmetic processing performed by the moving body 10 of the first embodiment with respect to step S1 where the determination on switching to the automatic guide operation mode is performed by the moving body 150 of this embodiment which can execute a traveling control in the automatic guide operation mode and step S3 where a target center-of-gravity position is calculated based on a target traveling state.

According to the moving body 150 of this embodiment, in the same manner as the moving body 100 of the second embodiment, the switching determination in step S1 in FIG. 3 is performed in accordance with steps indicated by a flowchart shown in FIG. 8. That is, when a switching instruction signal for switching a control mode to the automatic guide operation mode is inputted to the control device 50, the control device 50 selects the automatic operation mode and finishes the automatic operation switching determination. On the other hand, when the switching instruction signal for switching a control mode to the automatic guide operation mode is not inputted to the control device 50, the control device 50 selects the manipulation mode and finishes the automatic operation switching determination.

Further, according to the moving body 150 of this embodiment, in step S3, a target traveling state is obtained by arithmetic processing executed based on the destination, a traveling rout, a speed or the like set using the destination setting operation panel 155 or current position information detected by the GPS antenna 151, and a target center-of-gravity position corresponding to the target traveling state is also obtained. Here, in center-of-gravity position map information referenced at the time of obtaining the target center-of-gravity position corresponding to the target traveling state, the center-of-gravity position is positioned on an axis on which the pair of wheels 13L, 13R is arranged in a stationary state (speed of the moving body 150=zero), and the center-of-gravity position is decided corresponding to the traveling direction, the turning direction and acceleration. Arithmetic processing in respective steps other than the above-mentioned arithmetic processing is executed substantially in the same manner as the arithmetic processing executed in the first embodiment.

According to the moving body 150 of this embodiment explained heretofore, the manipulation mode where a traveling control of the moving body 150 is executed based on the intention of a rider and the automatic operation mode where a traveling control is executed to the destination set in advance can be selectively executed. In the automatic operation mode, outputs of the left wheel drive motor 31 and the right wheel drive motor 32 are controlled by shifting the center-of-gravity position based on a target traveling state in accordance with the destination, a traveling route or the like set in advance and hence, there is no possibility that a conflict occurs between an output of the translational operation control and an output of the inversion control.

Further, the moving body 150 of this embodiment is also configured such that, to shift the current center-of-gravity position to the target center-of-gravity position, a manipulated variable of the center-of-gravity position adjusting unit is decided based on a moving amount in the X-axis direction and a moving amount in the Y-axis direction on an X-Y plane which extends in the horizontal direction. Due to such a constitution, the center-of-gravity position can be speedily and accurately shifted to a target center-of-gravity position. Accordingly, it is possible to realize a guide operation to the destination with high accuracy.

The embodiments of the present invention explained heretofore may have the following modifications.

In the moving bodies 10, 100, 150 of the embodiments explained heretofore, as the center-of-gravity position adjusting unit, the mechanism which adjusts the center-of-gravity position by adjusting an inclination angle of the riding part 19 with respect to the horizontal direction is used. However, the specific constitution of the center-of-gravity position adjusting unit is not limited to these examples.

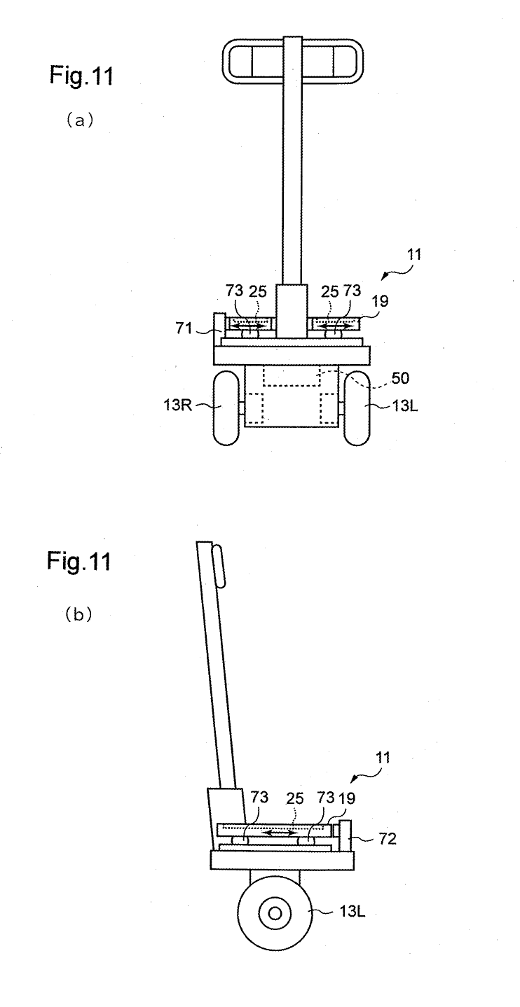

For example, FIG. 11A and FIG. 11B show an example of a moving body provided with a center-of-gravity position adjusting unit which is constituted of a mechanism where a center-of-gravity position is adjusted by shifting a position of the riding part 19 relative to a vehicle body 11. Such a center-of-gravity position adjusting unit is configured such that the riding part 19 is supported on a plurality of spherical bodies 73, and a position of the riding part 19 relative to the vehicle body 11 is adjusted by drive parts 71, 72 which are extensible and retractable in the directions orthogonal to each other in response to operation signals from the control device 50.

By constituting the center-of-gravity position adjusting unit in this manner, the center-of-gravity position can be directly shifted by sliding the riding part 19 in plane and hence, the adjustment of the center-of-gravity position can be easily performed. Also with the provision of such a center-of-gravity position adjusting unit, an automatic operation of the moving body can be performed by shifting the center-of-gravity position to a position which conforms to a target traveling state whereby it is possible to realize a moving body which can switch a control mode between the manipulation mode and the automatic operation mode.

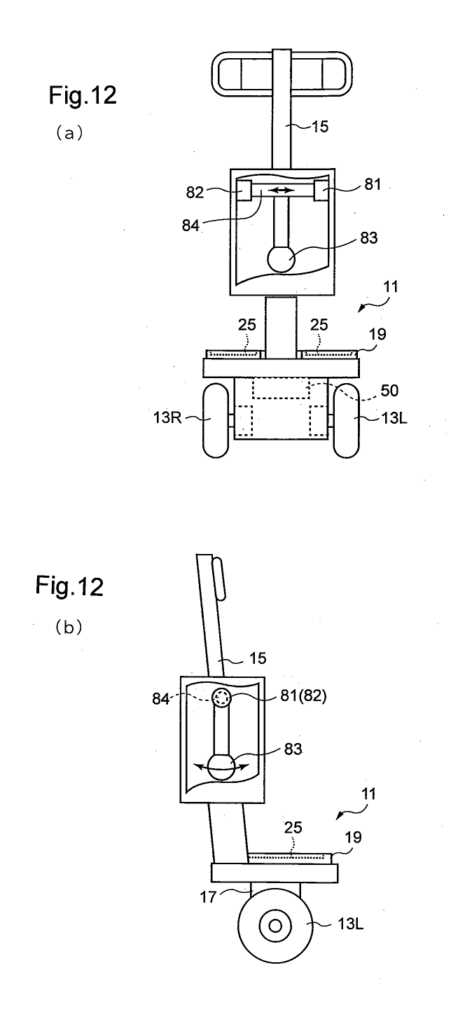

Further, as another example of the center-of-gravity position adjusting unit, FIG. 12 shows an example of a moving body which is provided with a center-of-gravity position adjusting unit which is constituted of an inertial body 83 whose position can be shifted relative to a vehicle body and drive parts 81, 82 which adjust the position of the inertial body 83. In this center-of-gravity position adjusting unit, the inertial body 83 is suspended from a rotary shaft 84 which extends in the lateral direction of the moving body. By adjusting the position of the inertial body 83 by the drive part 81 which shifts the inertial body 83 in the fore and aft direction of the moving body by rotating the rotary shaft 84 about an axis thereof and the drive part 82 which shifts the inertial body 83 in the lateral direction by shifting the rotary shaft 84 in the lateral direction of the moving body, the center-of-gravity position can be adjusted.

By constituting the center-of-gravity position adjusting unit in this manner, the center-of-gravity position can be shifted without moving the riding part 19 and hence, a discomfort which a rider feels can be reduced. Also with the provision of such a center-of-gravity position adjusting unit, an automatic operation of the moving body can be performed by shifting the center-of-gravity position to a position which conforms to a target traveling state whereby it is possible to realize a moving body which can switch a control mode between the manipulation mode and the automatic operation mode.

In the embodiments explained heretofore, as the unit for detecting a center-of-gravity position, besides the pressure sensitive sensor 25 and the strain gauge, the inclination angle sensor or the gyro sensor which detects an inclination angle of the riding part 19 is exemplified. However, the center-of-gravity position can be detected using an inclination angle sensor, a gyro sensor or the like which detects an inclination angle of the handle 15.

Further, it is also possible to provide a moving body which can perform all of automatic operation modes performed by the moving bodies 10, 100, 150 of the first to third embodiments explained heretofore or two modes out of these modes. The object of automatic operation is not particularly limited.

In the moving bodies 10, 100, 150 explained in conjunction with the embodiments heretofore, a traveling control is performed based on a center-of-gravity position of a rider also in the manipulation mode where the traveling control is executed based on the intention of the rider. However, a method of generating a traveling instruction as the intention of the rider in the manipulation mode is not limited to such a means. For example, a traveling instruction may be generated based on a manipulation of a control stick by a rider. In case of a moving body where a traveling control in the manipulation mode is performed in response to the manipulation of the control stick by a rider, after a control mode is switched to the automatic operation mode, a center-of-gravity position is adjusted by controlling a center-of-gravity position adjusting unit, and a traveling control is performed based on the center-of-gravity position.

Further, also with respect to the mode of the moving body, the present invention is applicable to, besides the coaxial two-wheeled vehicle exemplified in this embodiment, an inverted pendulum type moving body in general such as a moving body which uses a cylindrical one-wheeled rotary body or a moving body which uses a spherical rotary body provided that a traveling control is performed in accordance with a center-of-gravity position of a rider.

1. An inverted pendulum type moving body comprising:
a vehicle body having a riding part on which a rider rides;
a pair of wheels arranged on the same axis and rotatably supported on the vehicle body;
a wheel drive unit which rotatably drives the wheels;
a center-of-gravity position detecting unit for detecting a center-of-gravity position of the rider; and
a control device which controls the wheel drive unit for making the vehicle body travel while keeping a balance in accordance with a traveling instruction based on an intention of the rider;
wherein the inverted pendulum type moving body further comprises a center-of-gravity position adjusting unit for adjusting the center-of-gravity position of the rider in accordance with a manipulation signal output from the control device, and
the control device controls, when an instruction for switching a control mode to an automatic operation mode where a predetermined traveling control is performed without being based on the intention of the rider, the center-of-gravity position adjusting unit such that a target traveling state is obtained, and the wheel drive unit is controlled in accordance with a traveling instruction based on the center-of-gravity position.

2. The inverted pendulum type moving body according to claim 1, wherein the control device determines a manipulated variable of the center-of-gravity position adjusting unit based on a target center-of-gravity position for realizing a target traveling state and a center-of-gravity position detected using the center-of-gravity position detecting unit.

3. The inverted pendulum type moving body according to claim 1, wherein the automatic operation mode includes an automatic obstacle avoiding operation mode where an obstacle avoiding operation is automatically performed,
the inverted pendulum type moving body includes an obstacle detecting unit which detects information on an obstacle present in the periphery of the inverted pendulum type moving body, and
the control device switches a control mode to the automatic obstacle avoiding operation mode based on the traveling information on the inverted pendulum type moving body and the information on the obstacle, and outputs a manipulation signal for avoiding the obstacle.

4. The inverted pendulum type moving body according to claim 1, wherein the automatic operation mode includes an automatic cooperation operation mode where a cooperation operation with another moving body is automatically performed,
the control device switches a control mode to the automatic cooperation operation mode upon receiving an instruction for starting the cooperation operation, and outputs the manipulation signal in response to traveling information on another moving body.

5. The inverted pendulum type moving body according to claim 1, wherein the automatic operation mode includes an automatic guide operation mode where an automatic guide operation is performed until the moving body reaches a destination, and
the control device switches a control mode to the automatic guide operation mode upon receiving an instruction for starting the automatic guide operation, and outputs a manipulation signal in response to a set target traveling information.

6. The inverted pendulum type moving body according to claim 1, wherein the center-of-gravity position adjusting unit is constituted of a riding part inclination angle varying mechanism having a unit which adjusts an inclination angle of the riding part with respect to the horizontal direction in response to a manipulation signal.

7. The inverted pendulum type moving body according to claim 1, wherein the center-of-gravity position adjusting unit is constituted of a riding part position varying mechanism having a unit which adjusts a position of the riding part with respect to the vehicle body in response to a manipulation signal.

8. The inverted pendulum type moving body according to claim 1, wherein the center-of-gravity position adjusting unit is constituted of an inertial body whose position is changeable with respect to the vehicle body, and a unit which adjusts the position of the inertial body in response to a manipulation signal.
